(19) United States
(12) Patent Application Publication
(10) Pub. No.: US 2013/0092525 A1
(43) Pub. Date: Apr. 18, 2013

(54) CONCENTRIC FLOW-THROUGH PLASMA REACTOR AND METHODS THEREFOR

(71) Applicant: Innovalight, Inc., Santa Clara, CA (US)

(72) Inventors: Xuegeng Li, Santa Clara, CA (US); Maxim Kelman, Santa Clara, CA (US); Mason Terry, Santa Clara, CA (US); Elena Rogojina, Los Altos, CA (US); Eric Schiff, Santa Clara, CA (US); Karel Vanheusden, Santa Clara, CA (US)

(73) Assignee: Innovalight, Inc., Santa Clara, CA (US)

(21) Appl. No.: 13/706,837

(22) Filed: Dec. 6, 2012

Related U.S. Application Data
(62) Division of application No. 11/775,509, filed on Jul. 10, 2007.

(51) Int. Cl. H05H 1/24

(52) U.S. Cl. CPC H05H 1/2406
USPC 204/164

(57) ABSTRACT

The present invention provides a radiofrequency plasma apparatus for the production of nanoparticles and method for producing nanoparticles using the apparatus. The apparatus is designed to provide high throughput and makes the continuous production of bulk quantities of high-quality crystalline nanoparticles possible. The electrode assembly of the plasma apparatus includes an outer electrode and a central electrode arranged in a concentric relationship to define an annular flow channel between the electrodes.

### CROSS-REFERENCE TO RELATED APPLICATIONS

This application is a Divisional of U.S. application Ser. No. 11/775,509, filed Jul. 10, 2007, the entire contents of which are incorporated herein by reference.

### FIELD OF THE INVENTION

The present invention relates in general to nanoparticle technologies and in particular to methods and apparatus for use in the production of nanoparticles made from a variety of materials, including semiconductors.

### BACKGROUND

Nanoparticles have recently attracted significant attention from researchers in a variety of disciplines, due to a wide array of potential applications in the fabrication of nanostructured materials and devices. Semiconductor nanoparticles, such as silicon nanoparticles, are of special interest due to their potential uses in photovoltaic cells, photoluminescence-based devices, doped electroluminescent light emitters, memory devices and other microelectronic devices, such as diodes and transistors. Different methods have been used to synthesize free standing silicon nanoparticles. These methods include laser pyrolysis of silane, laser ablation of silicon targets, evaporation of silicon and gas discharge dissociation of silane.

Semiconductor nanoparticles have also been produced in plasmas. However, presently known plasma reactors may be poorly suited for the continuous, commercial scale production of high-quality nanoparticles. For example, one way of increasing the volume of generated nanoparticles is to increase the size of the plasma and hence the dimensions of the reaction chamber. However, as the size of the chamber increases, the plasma power density also tends to decrease toward to the center of the chamber, which becomes physically farther from the electrodes. This tends to decrease the quality and size of any generated nanoparticles.

Additionally, etching or sputtering of the dielectric layer that separates the electrodes form the RF (radio frequency) plasma may also be problematic. This sputtering has the potential to contaminate the resulting nanoparticles and reduce their suitability for a variety of applications. For example, when quartz is used as the dielectric material, silicon oxide can be etched or sputtered during the production of silicon nanoparticles using silane based RF plasma.

In view of the foregoing, there are desired methods and apparatus for use in the commercial scale production of nanoparticles made from a variety of materials.

### SUMMARY

The invention relates, in one embodiment, to a plasma processing apparatus. The plasma processing apparatus includes an outer tube, the outer tube including a first longitudinal length, an outer tube inner surface, and an outer tube outer surface. The plasma processing apparatus also includes an inner tube, the inner tube including a second longitudinal length and an inner tube outer surface, wherein the outer tube inner surface and the inner tube outer surface define an annular channel. The plasma processing apparatus further includes an outer electrode tube, the outer electrode tube having an outer electrode inner surface disposed on the outer tube outer surface. The plasma processing apparatus also includes a central electrode with a third longitudinal length, the central electrode being disposed inside the inner tube, the central electrode further configured to be coupled to the outer electrode when an RF energy source is applied to one of the outer electrode and the central electrode.

In another embodiment, the invention relates to a method for producing nanoparticles in a plasma apparatus. The method includes introducing a nanoparticle precursor gas into an annular channel. The method also includes igniting a radiofrequency plasma in the annular channel, whereby the nanoparticle precursor gas dissociates and forms nanoparticles

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-C show a set of schematic diagrams of a concentric flow-through plasma reactor, in accordance with the present invention;

FIGS. 2A-B show a set of simplified diagrams of a concentric-flow through plasma reactor with short central electrode, in accordance with the present invention;

FIGS. 3 shows a simplified diagram of a plurality of concentric electrodes in a tandem configuration, in accordance with the present invention;

FIG. 4 shows a simplified diagram of a plurality of nested electrode assemblies about a single longitudinal axis, in accordance with the present invention;

FIG. 5 shows a simplified diagram of a concentric-flow through plasma reactor system, in accordance with the present invention;

FIG. 6 shows the conductivities of the films produced using the different reactor configurations, in accordance with the present invention;

FIG. 7 shows a graph comparing the Fourier transform infrared spectroscopy (FTIR) spectrum for a powder of silicon nanoparticles, in accordance with the present invention; and

FIG. 8 shows a simplified graph of a FTIR of FIG. 7.

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In an advantageous manner, a concentric-flow through plasma reactor may be used to produce commercial-scale quantities of high-quality crystalline nanoparticles in a substantially continuous fashion, such as Group IV nanoparticles (i.e., silicon (Si), germanium (Ge), etc.) and nanoparticle alloys (i.e., SiGe, etc.). In addition, the current invention may be used to form other types of nanoparticles, including metal nanoparticles, metal alloy nanoparticles, metal oxide nanoparticles, metal nitride nanoparticles, and ceramic nanoparticles, depending upon the type of nanoparticle precursor gases used. As discussed in more detail below, the nanoparticles may be doped nanoparticles and/or core/shell nanoparticles.

As used herein, the term “Group IV nanoparticle” generally refers to hydrogen terminated Group IV nanoparticles having an average diameter between about 1 nm to 100 nm, and composed of silicon, germanium, and alpha-tin, carbon, or combinations thereof. The term “Group IV nanoparticle” also includes Group IV nanoparticles that are doped. With respect to shape, embodiments of Group IV nanoparticles include elongated particle shapes, such as nanowires, or irregular shapes, in addition to more regular shapes, such as spherical, hexagonal, and cubic nanoparticles, and mixtures thereof.

Group IV semiconductor nanoparticles are generally used in a variety of applications. Due to their unique optical, electronic, and physical properties, these particles are of great interest for their use in optoelectronic devices, such as photovoltaic cells, light-emitting diodes, photodiodes, and sensors that utilize their unique optical and semiconductor properties. Other potential applications may use the unique luminescent properties of small nanoparticles. Silicon and germanium nanoparticles have been contemplated for use in light-emitting applications, including use as phosphors for solid-state lighting, luminescent taggants for biological applications, security markers and related anti-counterfeiting measures. Because of the ability to produce colloidal forms of semiconductor nanoparticles, these materials offer the potential of low-cost processing, such as printing, that is not possible with conventional semiconductor materials.

Nanoparticles have an intermediate size between individual atoms and macroscopic bulk solids. In some embodiments, Group IV nanoparticles have a size on the order of the Bohr exciton radius (e.g. 4.9 nm for silicon), or the de Broglie wavelength, which allows individual Group IV nanoparticles to trap individual or discrete numbers of charge carriers, either electrons or holes, or excitons, within the particle. The nanoparticles may exhibit a number of unique electronic, magnetic, catalytic, physical, optoelectronic and optical properties due to quantum confinement and surface energy effects. For example, Group IV nanoparticles exhibit luminescence effects that are significantly greater than, as well as melting temperatures that are substantially lower than their complementary bulk Group IV materials.

These unique effects vary with properties such as size and elemental composition of the nanoparticles. For instance, the melting of germanium nanoparticles is significantly lower than the melting of silicon nanoparticles of comparable size. With respect to quantum confinement effects, for silicon nanoparticles, the range of nanoparticle dimensions for quantum confined behavior is between about 1 nm to about 15 nm, while for germanium nanoparticles, the range of nanoparticle dimensions for quantum confined behavior is between about 1 nm to about 35 nm, and for alpha-tin nanoparticles, the range of nanoparticle dimensions for quantum confined behavior is between about 1 nm to about 40 nm. In another example, some embodiments of Group IV nanoparticles exhibit photoluminescence effects that are significantly greater than the photoluminescence effects of macroscopic materials having the same composition. Since these photoluminescence effects vary as a function of the size of the nanoparticle, the color of light emitted in the visible portion of the electromagnetic spectrum varies with nanoparticle size.

Additionally, the nanoparticles may be single-crystalline, polycrystalline, or amorphous in nature. As such, a variety of types of Group IV nanoparticle materials may be created by varying the attributes of composition, size, shape, and crystallinity of Group IV nanoparticles. Exemplary types of Group IV nanoparticle materials are yielded by variations including: 1) single or mixed elemental composition; including alloys, core/shell structures, doped nanoparticles, and combinations thereof; 2) single or mixed shapes and sizes, and combinations thereof; and 3) single form of crystallinity or a range or mixture of crystallinity, and combinations thereof.

Particle quality includes, but is not limited by, particle purity, particle morphology, average size and size distribution. Notably, as illustrated in Example 2, below, Group IV nanoparticles made with the current invention may have a lower concentration of SiO₂ impurities than Group IV nanoparticles made in more conventional plasma reactors. SiO₂ is a very common contaminant for silicon and silicon nanoparticles and is known to reduce the electrical performance of silicon.

One measure of the quality of Group IV nanoparticles is the conductivity of thin films made from the Group IV nanoparticles. Such thin films may be well-suited for use in the active layer of photovoltaic cells. Using the present apparatus, thin films incorporating Group IV nanoparticles made in the present apparatus may provide increased conductivity, lower processing temperature dependence and more consistent reproducibility relative to thin films incorporating Group IV nanoparticles made in other plasma reactors. This is illustrated in detail in the Example section, below.

As previously stated, it may be difficult to commercially scale current plasma reactor configurations for commercial scale production of high-quality nanoparticles. In generally, as the size of the chamber increases, the plasma power density also tends to decrease toward to the center of the chamber, which becomes physically farther from the electrodes. However, this tends to decrease the quality and size of any generated nanoparticles.

In an advantageous fashion, the current invention allows the creation of a toroid-shaped (doughnut-shaped) plasma about the longitudinal axis (parallel to the precursor flow path) of the plasma reactor. Consequently, the lateral radius of the plasma (and hence the plasma volume) may be increased without increasing (or with a controlled increase in) the height of the gap between the central electrode and the outer electrode. Thus for a given set of process conditions (e.g., voltage, gas flow mix, pressure, etc.) optimized for a particular nanoparticle crystallinity and homogeneity level, an optimum gap distance (or range of gap distances) may also be determined and maintained as the overall plasma volume (and nanoparticle production rate) is increased.

In addition, the current invention generally avoids the problems associated with the build-up of a conductive film between the ground and radiofrequency electrodes which may be problematic for non-concentric plasma reactors. In general, when conductive nanoparticles are produced in a non-concentric plasma reactor, a conductive film may build up on the plasma chamber wall between the electrodes. Eventually, this film leads to shorting between the electrodes which quenches the plasma. As a result, such plasma reactors may only be run for a limited time before they must be dismantled and cleaned, limiting the maximum rate of nanoparticle production.

Since substantially less conductive film tends to build up across the annular channel between the concentric electrodes, the current invention may be run continuously for long periods of time making possible the production of commercial-scale quantities of nanoparticles. For example, the plasma apparatus is capable of producing at least about 1 g of silicon nanoparticles per hour for 3 hours without interruption.

In one embodiment, the apparatus includes an outer tube, an outer tube dielectric layer disposed over an inner surface of the outer tube, a tube-shaped outer electrode surrounding at least a portion of the outer tube, a tube-shaped inner electrode, an inner tube surrounding the tube-shaped inner electrode, and an inner tube dielectric layer disposed over the outer surface of the tube-shaped inner tube. In addition, the tube-shaped inner electrode is positioned concentrically along a longitudinal axis with respect to the tube-shaped outer electrode.

A set of flanges may be applied to the ends of the outer cylinder, such that low pressure may be maintained in an annular channel (corresponding to a plasma reaction zone) formed between the outer tube dielectric layer and the inner tube dielectric layer. In addition, the area outside the outer cylinder and inside the inner cylinder is generally maintained at ambient pressure.

When the plasma reactor is in operation, nanoparticle precursor gases are generally flowed through the annular channel and ignited in a reaction zone between the electrodes when an RF signal is applied to one of the electrodes (e.g., powered electrode). Within the plasma, precursor gas molecules may dissociate and form nanoparticles which may be collected in, or downstream of, the reaction zone.

In one configuration, the cross-sectional area of the inner tube and the outer tube forms a circle. In another configuration, the cross-sectional area of the inner tube and the outer tube forms an ellipse. In yet another configuration, the cross-sectional area of the inner tube and the outer tube forms a racetrack shape. In yet another configuration, the cross-sectional area of the inner tube and the outer tube forms a rectangular shape. In yet another configuration, the cross-sectional area of the inner tube and the outer tube forms a square shape.

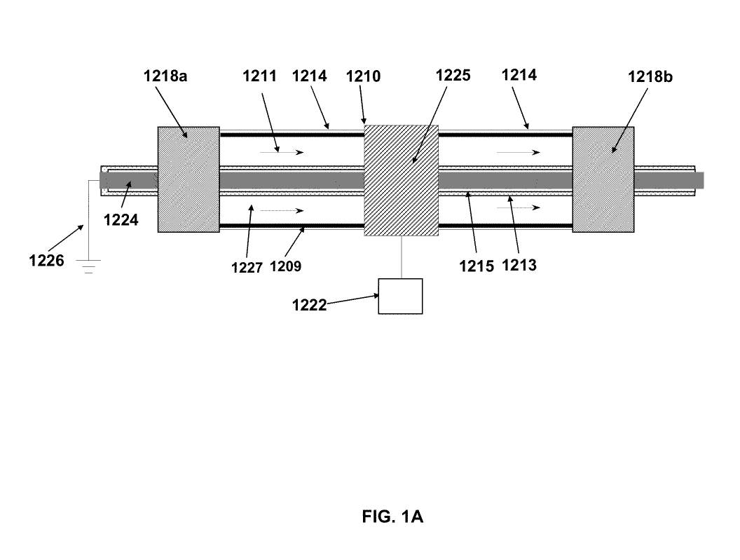

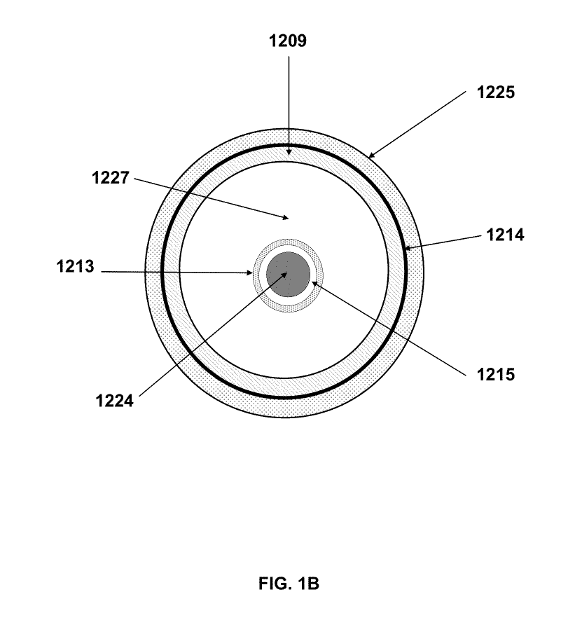

Referring now to FIGS. 1A-C, a set of schematic diagrams of a concentric flow-through plasma reactor is shown, in accordance with the present invention. FIG. 1A shows a side view. FIG. 1B shows a cross-sectional view. FIG. 1C shows the cross-sectional view of FIG. 1B with the addition of a coating on a first dielectric and a second dielectric.

In general, the concentric flow-through plasma reactor is configured with an outer tube 1214 and an inner tube 1215 concentrically positioned along a longitudinal axis with respect outer tube 1214. An annular channel 1227, defined by the area inside outer tube 1214 and outside inner tube 1215, may be sealed from the ambient atmosphere by inlet port flange 1218a and outlet port flange 1218b.

A plasma reaction zone (i.e., the zone in which the nanoparticles are created) is defined as an area inside annular channel 1227 between a tube-shaped outer electrode 1225 (positioned outside outer tube 1214) and a tube-shaped central electrode 1224 (central electrode tube), positioned concentrically along a longitudinal axis with respect to tube-shaped outer electrode 1225 (outer electrode tube), and further positioned inside inner tube 1215. Typically, the precursor gas or gases may be introduced into annular channel 1227 along flow path 1211 from a precursor gas source in fluid communication with an inlet port (not shown) on inlet port flange 1218a. Similarly, nanoparticles produced within the plasma reactor chamber may exit through an exit port (not shown) on outlet port flange 1218b into a nanoparticle collection chamber (not shown). Alternatively, the nanoparticles may be collected on a substrate or grid housed in the plasma reactor chamber.

In general, tube-shaped central electrode 1224 is configured to extend along a substantial portion of the plasma reactor. In additional, tube-shaped central electrode 1224 and tube-shaped outer electrode 1225 may be made of any sufficiently electrically conductive materials, including metals, such as copper or stainless steel.

Outer tube 1214 may be further shielded from the plasma by outer tube dielectric layer 1209 disposed on the inner surface of outer tube 1214. In general, outer tube 1214 may be any material that does not substantially interfere with the generated plasma, such as a dielectric material. In an embodiment, outer tube 1214 and outer tube dielectric layer 1209 are comprised of different materials, such as different dielectric materials. In an alternate embodiment, outer tube 1214 and outer tube dielectric layer 1209 are the same physical structure and material, such as quartz. Likewise, inner tube 1215 may be further shielded from the plasma by inner tube dielectric layer 1213. Examples of dielectric materials include, but are not limited to, quartz, sapphire, fumed silica, polycarbonate alumina, silicon nitride, silicon carbide, and borosilicate.

In an alternative design, tube-shaped central electrode 1224 may be pulled back such that the front (i.e., upstream) face of tube-shaped central electrode 1224 is aligned with (i.e., in the same plane as) the front face 1210 of tube-shaped outer electrode 1225. This configuration tends to create a shaper leading edge to the plasma, resulting in an increase in plasma power density and, therefore, a higher degree of crystallinity in the nanoparticles.

In one configuration, RF energy source and matching network 1222 may be coupled to tube-shaped outer electrode 1225, while tube-shaped central electrode 1224 may be coupled to ground 1226. In an alternate configuration, RF energy source and matching network 1222 may be coupled to tube-shaped central electrode 1224, while tube-shaped outer electrode 1225 may be coupled to ground 1226. Additionally, the RF source may operate at the commercial band frequency of 13.56 MHz, although other frequencies could also be used.

Additionally, as shown in FIG. 1C, the surfaces of outer tube 1214 and outer tube dielectric layer 1209 may be optionally coated with a lower sputtering dielectric material, such as silicon nitride, to avoid sputtering and/or nanoparticle contamination while the plasma reactor is in operation. That is, a first silicon nitride 1231 layer may be disposed on the inner surface of outer tube 1214, and a second silicon nitride layer 1233 may be disposed on the outer surface of inner tube dielectric layer 1213.

As previously described, it is desirable to select a dielectric material that has a low sputtering rate under the plasma operating conditions and/or that produces sputtering products that do not have a significant negative impact on the quality of the nanoparticles produced in the plasma. A contaminant such as oxygen that may be incorporated into nanoparticles when a quartz dielectric layer is sputtered may have a negative impact on the electronic properties of an electronic device fabricated from such nanoparticles. Oxygen contamination can be eliminated by using dielectric layers made of materials, such as silicon nitride (SiNₓ), that do not contain oxygen. Oxygen contamination can also be substantially minimized by using a dielectric material that has a lower sputtering rate than quartz. For example, the dielectric material may have an argon sputtering rate that is no greater than about 75% and more desirably no greater than about 50% of quartz.

Dielectric materials that have low sputtering rates and that do not produce detrimental impurities in Group IV nanoparticles include, but are not limited to, group IV semiconductors, sapphire, polycarbonate alumina, silicon nitride, silicon carbide or borosilicate. Silicon nitride is a particularly attractive dielectric material. Silicon nitride has a slower sputtering rate than quartz and, although silicon nitride may produce nitrogen contamination in the nanoparticles, nitrogen contamination is less detrimental than oxygen contamination in silicon. The argon sputtering rate for SiO₂ is 0.1 molecules/ion as compared with an argon sputtering rate for Si₃N₄ of 0.05 molecules/ion.

In the present electrode assemblies, the dielectric layers themselves may be made of low sputtering materials. Alternatively, higher sputtering dielectric layers, such as quartz, Pyrex or borosilicate glass layers, may be coated with a film of lower sputtering dielectric materials on the surfaces that are exposed to the radiofrequency plasma. This latter approach may be advantageous from a cost perspective. When a coating is used, it may be advantageous to reform the coating during or after reactor operation since the coatings eventually may be sputtered or etched away. A method for forming a silicon nitride film on a dielectric layer is described in Example 3, below.

By way of illustration only, in some embodiments the height of the gap between the outer surface of tube-shaped central electrode 1224 and the inner surface of tube-shaped outer electrode 1225 will be no greater than 30 mm. This includes embodiments where the height of the gap is about 5 mm to about 20 mm and further includes embodiments where the height of the gap is about 8 mm to about 15 mm.

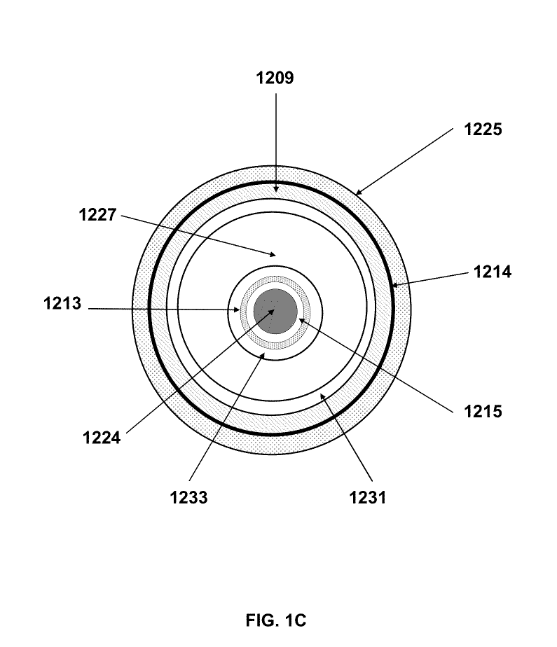

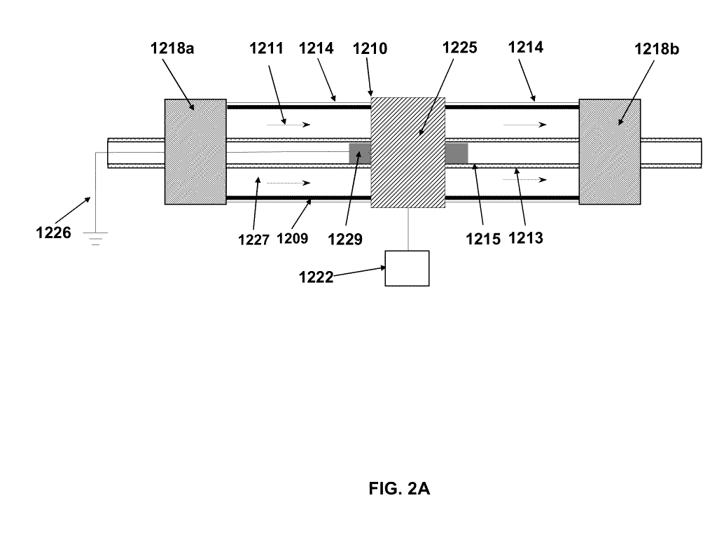

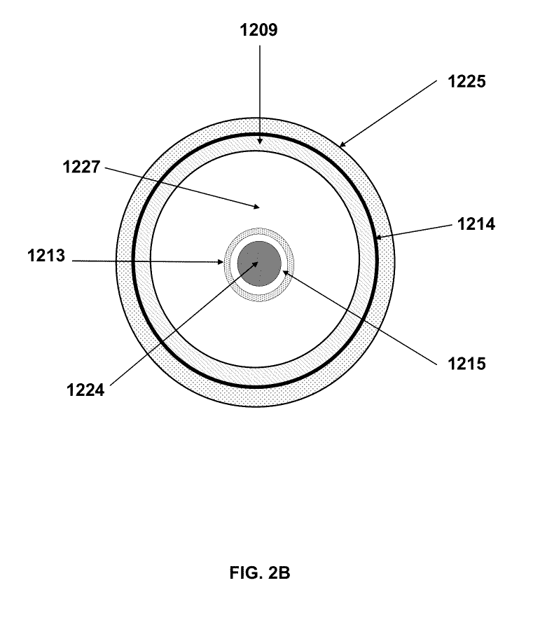

Referring now to FIGS. 2A-B, a set of simplified diagrams of a concentric-flow through plasma reactor with short central electrode is shown, in accordance with the present invention. FIG. 2A shows a side view of a concentric flow-through plasma reactor. FIG. 2B shows a cross-sectional view a concentric flow-through plasma reactor.

As before, the concentric flow-through plasma reactor is configured with an outer tube 1214 and an inner tube 1215 concentrically positioned along a longitudinal axis with respect outer tube 1214. An annular channel 1227, defined by the area inside outer tube 1214 and outside inner tube 1215, may be sealed from the ambient atmosphere by inlet port flange 1218a and outlet port flange 1218b.

A plasma reaction zone (i.e., the zone in which the nanoparticles are created) is defined as an area inside annular channel 1227 between a tube-shaped outer electrode 1225 (positioned outside outer tube 1214) and a short tube-shaped central electrode 1229, positioned concentrically along a longitudinal axis with respect to tube-shaped outer electrode 1225, and further positioned inside inner tube 1215. Unlike in FIGS. 1A-C, short tube-shaped central electrode 1229 does not extend along a substantial portion of the plasma reactor, but rather may be positioned around tube-shaped outer electrode 1225.

Typically, the precursor gas or gases may be introduced into annular channel 1227 along flow path 1211 from a precursor gas source in fluid communication with an inlet port (not shown) on inlet port flange 1218a. Similarly, nanoparticles produced within the plasma reactor chamber may exit through an exit port (not shown) on outlet port flange 1218b into a nanoparticle collection chamber (not shown). Alternatively, the nanoparticles may be collected on a substrate or grid housed in the plasma reactor chamber.

In general, short tube-shaped central electrode 1229 is configured to extend along a substantial portion of the plasma reactor. In additional, tube-shaped central electrode 1224 and tube-shaped outer electrode 1225 may be made of any sufficiently electrically conductive materials, including metals, such as copper or stainless steel.

Outer tube 1214 may be further shielded from the plasma by outer tube dielectric layer 1209 disposed on the inner surface of outer tube 1214. In general, outer tube 1214 may be any material that does not substantially interfere with the generated plasma, such as a dielectric material. In an embodiment, outer tube 1214 and outer tube dielectric layer 1209 are comprised of different materials, such as different dielectric materials. In an alternate embodiment, outer tube 1214 and outer tube dielectric layer 1209 are the same physical structure and material, such as quartz. Likewise, inner tube 1215 may be further shielded from the plasma by inner tube dielectric layer 1213. The dielectric layers may be made of any sufficiently electrically insulating materials, including, but not limited to, quartz, sapphire, fumed silica, polycarbonate alumina, silicon nitride, silicon carbide, or borosilicate.

In one configuration, RF energy source and matching network 1222 may be coupled to tube-shaped outer electrode 1225, while short tube-shaped central electrode 1229 may be coupled to ground 1226. In an alternate configuration, RF energy source and matching network 1222 may be coupled to short tube-shaped central electrode 1229, while tube-shaped outer electrode 1225 may be coupled to ground 1226. Additionally, the RF source may operate at the commercial band frequency of 13.56 MHz, although other frequencies could also be used.

By way of illustration only, in some embodiments the height of the gap between the outer surface of short tube-shaped central electrode 1229 and the inner surface of tube-shaped outer electrode 1225 will be no greater than 30 mm. This includes embodiments where the height of the gap is about 5 mm to about 20 mm and further includes embodiments where the height of the gap is about 8 mm to about 15 mm.

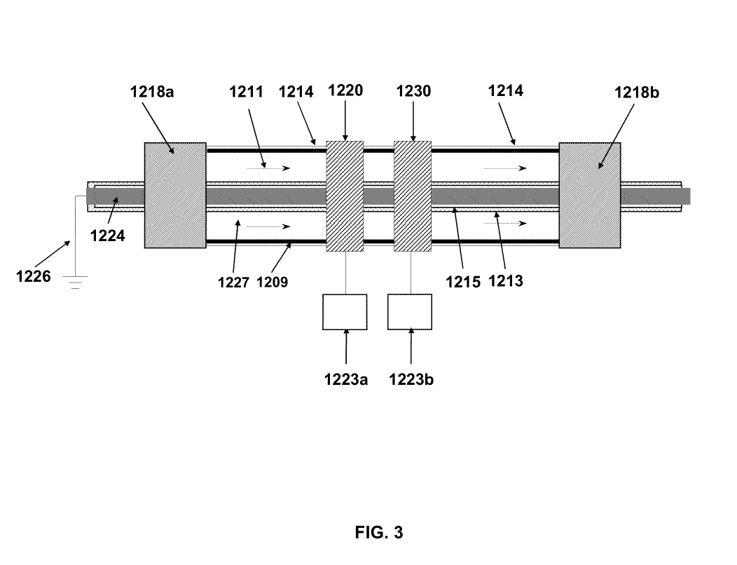

Referring now to FIG. 3, a simplified diagram of a plurality (i.e., two or more) of concentric electrodes in a tandem configuration is shown, in accordance with the present invention.

In general, the concentric flow-through plasma reactor is configured with an outer tube 1214 and an inner tube 1215 concentrically positioned along a longitudinal axis with respect outer tube 1214. An annular channel 1227, defined by the area inside outer tube 1214 and outside inner tube 1215, may be sealed from the ambient atmosphere by inlet port flange 1218a and outlet port flange 1218b.

A first plasma reaction zone is defined as an area inside annular channel 1227 between a first tube-shaped outer electrode 1220 (positioned outside outer tube 1214) and a tube-shaped central electrode 1224, positioned concentrically along a longitudinal axis with respect to tube-shaped outer electrode 1225, and further positioned inside inner tube 1215. A second plasma reaction zone is defined as an area inside annular channel 1227 between a second tube-shaped outer electrode 1230 (positioned outside outer tube 1214) and the tube-shaped central electrode 1224.

Typically, the precursor gas or gases may be introduced into annular channel 1227 along flow path 1211 from a precursor gas source in fluid communication with an inlet port (not shown) on inlet port flange 1218a. Similarly, nanoparticles produced within the plasma reactor chamber may exit through an exit port (not shown) on outlet port flange 1218b into a nanoparticle collection chamber (not shown). Alternatively, the nanoparticles may be collected on a substrate or grid housed in the plasma reactor chamber.

In general, tube-shaped central electrode 1224 is configured to extend along a substantial portion of the plasma reactor. In additional, tube-shaped central electrode 1224, first tube-shaped outer electrode 1220, and second tube-shaped outer electrode 1230, may be made of any sufficiently electrically conductive materials, including metals, such as copper or stainless steel.

Outer tube 1214 may be further shielded from the plasma by outer tube dielectric layer 1209 disposed on the inner surface of outer tube 1214. In general, outer tube 1214 may be any material that does not substantially interfere with the generated plasma, such as a dielectric material. In an embodiment, outer tube 1214 and outer tube dielectric layer 1209 are comprised of different materials, such as different dielectric materials. In an alternate embodiment, outer tube 1214 and outer tube dielectric layer 1209 are the same physical structure and material, such as a dielectric material. Likewise, inner tube 1215 may be further shielded from the plasma by inner tube dielectric layer 1213. The dielectric layers may be made of any sufficiently electrically insulating materials, including, but not limited to, quartz, sapphire, fumed silica, polycarbonate alumina, silicon nitride, silicon carbide, or borosilicate.

In one configuration, RF energy source and first matching network 1223a may be coupled to first tube-shaped outer electrode 1220, RF energy source and second matching network 1223b may be coupled to second tube-shaped outer electrode 1230, and tube-shaped central electrode 1224 may be coupled to ground 1226. Additionally, the RF energy source may operate at a commercial band frequency of 13.56 MHz, although other frequencies could also be used.

In an alternate configuration, first tube-shaped outer electrode 1220 may be coupled to RF energy source and first matching network 1223a, while second tube-shaped outer electrode 1230 and tube-shaped central electrode 1224 may be coupled to ground 1226.

If core/shell nanoparticles are desired, the process may be carried out in the concentric flow-through plasma reactor, using a first precursor gas comprising nanoparticle core precursor molecules and a second precursor gas comprising nanoparticle shell precursor molecules. In this process, the nanoparticle core precursor gas may be passed into the plasma reaction zone within the annular channel of the first tub-shaped outer electrode 1220 where the nanoparticle core precursor molecules in the gas dissociate and form nanoparticle cores.

The nanoparticle shell precursor gas is then passed into the plasma reaction zone within the annular channel of the second cylindrical outer electrode 1230, along with the nanoparticle cores, where the nanoparticle shell precursor molecules in the gas dissociate and form nanoparticle shells over the nanoparticle cores.

By way of illustration, Group IV nanoparticle cores may be prepared having shells of other Group IV semiconductors, carbide, nitride, sulfide and other oxide shell compositions. Suitable nanoparticle precursor molecules for forming Group IV semiconductors (including core and shell precursors) include, but are not limited to, silane and germane, which may be used in the production of silicon and germanium nanoparticles, respectively. Organometallic precursor molecules may also be used. These molecules include a Group IV metal and organic groups. Organometallic Group IV precursors include, but are not limited to, organosilicon, organogermanium and organotin compounds. Some examples of Group IV precursors include, but are not limited to, alkylgermaniums, alkylsilanes, alkylstannanes, chlorosilanes, chlorogermaniums, chlorostannanes, aromatic silanes, aromatic germaniums and aromatic stannanes.

Other examples of silicon precursors include, but are not limited to, disilane (Si₂H₆), silicon tetrachloride (SiCl₄), trichlorosilane (HSiCl₃) and dichlorosilane (H₂SiCl₂). Still other suitable precursor molecules for use in forming crystalline silicon nanoparticles include alkyl and aromatic silanes, such as dimethylsilane (H₃C—SiH₂—CH₃), tetraethyl silane ((CH₃CH₂)₄Si) and diphenylsilane (Ph—SiH₂—Ph). In addition to germane, particular examples of germanium precursor molecules that may be used to form crystalline Ge nanoparticles include, but are not limited to, tetraethyl germane ((CH₃CH₂)₄Ge) and diphenylgermane (Ph—GeH₂—Ph).

Suitable dopant precursor molecules for Group IV semiconductor nanoparticles include n-type dopant precursors, such as phosphine, or arsine. Suitable p-type dopant precursor molecules include boron diflouride, trimethyl borane, or diborane. A description of suitable precursor molecules for producing other types of nanoparticles, including Group IV-IV nanoparticles, Group II-VI nanoparticles, Group III-V nanoparticles, metal nanoparticles, metal alloy nanoparticles, metal oxide nanoparticles, metal nitride nanoparticles, and ceramic nanoparticles may be found in U.S. Patent Application Publication No. 2006/051505, the entire disclosure of which is incorporated herein by reference.

By way of illustration only, in some embodiments the height of the gap between the outer surface of the central electrode and the inner surface of the outer electrode will be no greater than 30 mm. This includes embodiments where the height of the gap is about 5 mm to about 20 mm and further includes embodiments where the height of the gap is about 8 mm to about 15 mm.

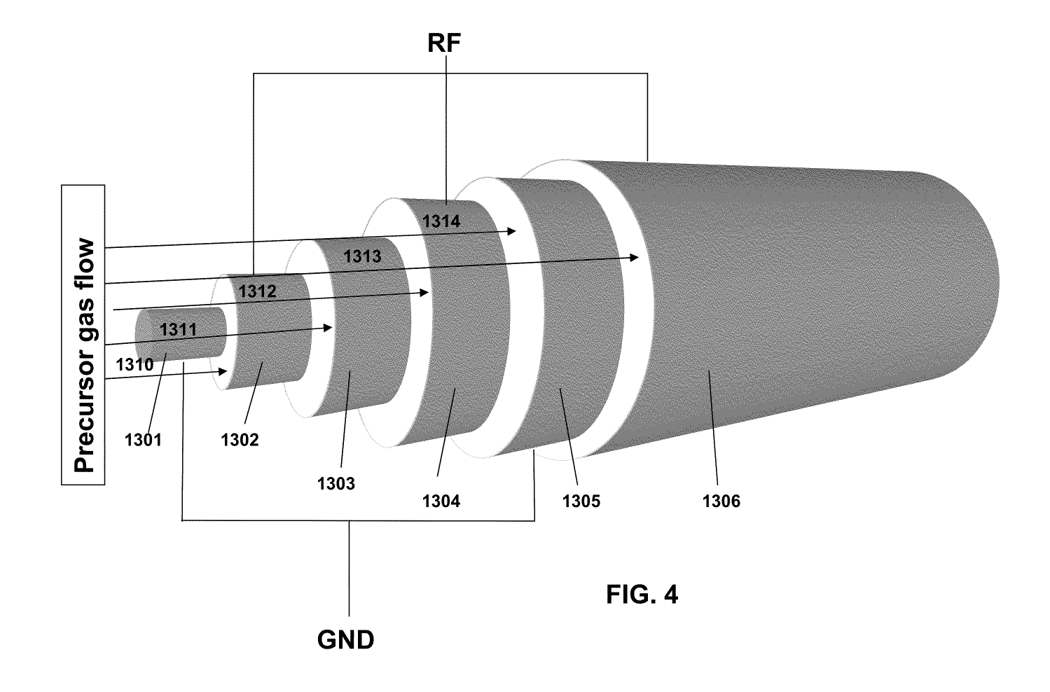

Referring now to FIG. 4, a simplified diagram of a plurality of nested electrode assemblies about a single longitudinal axis is shown, in accordance with the present invention. In this configuration, a plurality of tube-shaped central electrodes are shown (first tube-shaped central electrode 1301, second tube-shaped central electrode 1302, third tube-shaped central electrode 1303, fourth tube-shaped central electrode 1304, fifth tube-shaped central electrode 1305, and sixth tube-shaped central electrode 1306) arranged in a concentric relationship, with first tube-shaped central electrode 1301 having the smallest diameter and sixth tube-shaped central electrode 1306 having the largest diameter.

In an alternate configuration, sets of proximate electrodes are coupled. For example, a second tube-shaped powered electrode 1302 may be coupled to both first tube-shaped grounded electrode 1301 (with precursor gas flow 1310), and third tube-shaped grounded electrode 1303 (with precursor gas flow 1311). Additionally,

a fourth tube-shaped powered electrode 1304 may be coupled to both third tube-shaped grounded electrode 1303 (with precursor gas flow 1312), and fifth tube-shaped grounded electrode 1305 (with precursor gas flow 1313). Finally, a sixth tube-shaped powered electrode 1306 may be coupled to fifth tube-shaped grounded electrode 1305 (with precursor gas flow 1314). The result is generally an electrode assembly with a plurality of concentric plasma reaction zones that may be operated simultaneously to increase throughput and maximize nanoparticle production. For example, precursor gas flow 1310 may be flowed between. As described above, the surfaces of the electrodes are desirably coated with a dielectric material to avoid sputtering while the plasma reactor is in operation.

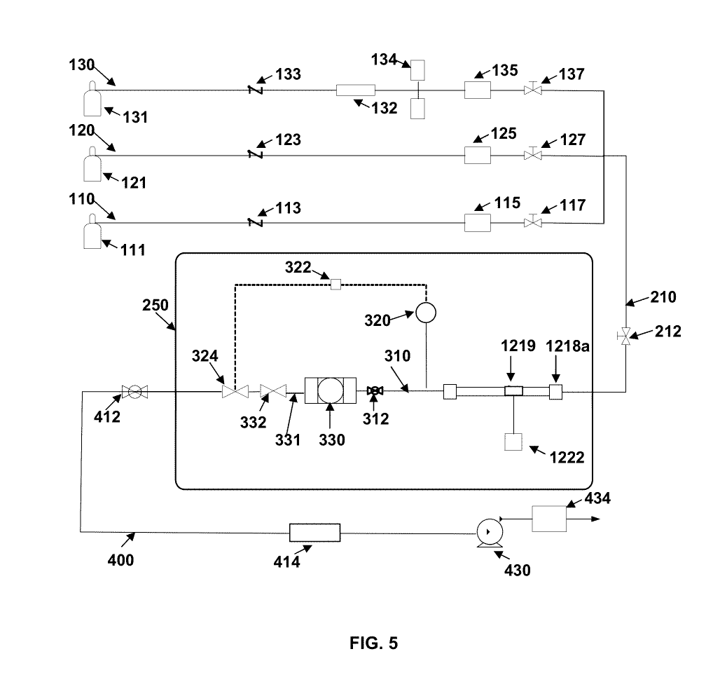

FIG. 5 shows a simplified diagram of a concentric-flow through plasma reactor system, in accordance with the present invention. In general, the electrode assemblies and plasma reactor chambers described above may be readily incorporated into a larger plasma reactor system which may include additional external components such as a precursor gas inlet manifold, a nanoparticle collection manifold, and a pressure control system.

Typically, the precursor gas inlet manifold typically includes one or more precursor gas sources and, optionally, one or more buffer gas sources in fluid communication with one or more inlet ports in the plasma reactor chamber. Generally, the precursor and buffer gas sources are connect to the chamber through pressure regulators, stop valves and/or gas flow controllers. The nanoparticle collection manifold typically includes a nanoparticle collection chamber in fluid communication with an outlet port in the plasma reactor chamber.

The nanoparticle collection chamber may be connected to the plasma reactor chamber through a sealable value in order to allow the nanoparticles to be removed from the apparatus without exposing the plasma reactor chamber to the ambient atmosphere. The pressure control system typically includes one or more pumps in fluid communication with the plasma reactor chamber, the gas inlet manifold and the nanoparticle collection manifold, such that the pressure within the system may be reduced and precisely controlled to avoid contamination of the nanoparticles during production and collection.

First gas line 130 is a generalized gas line comprised of a first gas source 131, a first gas line trap 132 for scrubbing oxygen and water from the gas, a first gas line analyzer 134 for monitoring oxygen and water levels to ensure that they are effectively removed from the gas phase reactor lines, a first gas line mass flow controller 135, and a first gas line valve 137. All elements comprising the first gas line 130 are in fluid communication with one another through first gas line conduit 133. First gas line 130 could be useful as, for example, a nanoparticle precursor gas line. As discussed in greater detail below, the nanoparticle precursor gases passes through these lines may include primary nanoparticle precursor gases, nanoparticle dopant precursor gases, nanoparticle core precursor gases, nanoparticle shell precursor gases, buffer gases, or a combination thereof.

When a gas line is used to deliver a nanoparticle dopant precursor gas, first gas line trap 132 is optional for scrubbing oxygen and water from the dopant gas in cases where the dopant gas is not aggressive and can be effectively filtered. Additionally, the first gas line analyzer 134 for monitoring oxygen and water levels to ensure that they are effectively removed from the RF plasma reactor lines, may be also optional for the same reason. This is shown in second gas line 120 and third gas line 110 which include second gas source 121 and third gas source 111, second conduit 123 and third conduit 113, second flow controller 125 and third flow controller 115, and second gas line valve 124 and third gas line valve 117, but may lack gas line traps and analyzers.

Gases from first gas line 130, second gas line 120, and third gas line 110 are in fluid communication with the plasma reactor chamber through inlet line 210, which includes an inlet line valve 212. Inlet line 210 passes through an inlet port flange 1218a. Precursor and buffer gases are introduced into the plasma reactor chamber through the inlet port and flow continuously through the annular channel of electrode assembly 1219 where nanoparticles are formed in the plasma reaction zone. The resulting nanoparticles are then collected in a nanoparticle collection manifold. The collection manifold may take on many forms. In one simple embodiment, the “collection manifold” is a grid or mesh located in or downstream of the plasma reaction zone in the plasma reactor. Alternatively, the nanoparticles may be collected in a nanoparticle collection chamber in fluid communication with the plasma reactor chamber through an outlet port in the chamber.

For example, the nanoparticles may exit the plasma reactor chamber through outlet line 310 and collect in nanoparticle collection chamber 330 which is separated from the plasma reactor chamber by inlet valve 312. The effluent gas flows from the nanoparticle collection chamber 330 out through the nanoparticle collector outlet line 331, which has outlet valve 332. The pressure control system for the nanoparticle collection manifold is composed of a pressure sensor 320, controller 322 and a butterfly valve 324, which may be, for example, a butterfly valve. During typical operation, inlet valve 312 and outlet valve 332 are open, but butterfly valve 324 is partially open. As nanoparticles are collected in nanoparticle collection chamber 330, pressure builds up, and is detected by pressure sensor 320, which, through a controller 322 opens butterfly valve 324 to keep the pressure constant. Downstream from the nanoparticle collection manifold is the exhaust assembly, which includes an exhaust line 400, isolation valve 412, particle trap 414, and pump 430 with a mist trap 434.

In order to ensure nanoparticle purity, the nanoparticle reactor chamber and, optionally, the precursor gas inlet manifold and the nanoparticle collection manifold may be contained in a sealed, inert environment, such as glove box 250. For the purposes of this disclosure, an inert environment is an environment in which there are no fluids (i.e., gases, solvents, and solutions) that react in such a way that they would negatively affect properties such as the semiconductor, photoelectrical, and luminescent properties of the nanoparticles.

In that regard, an inert gas is any gas that does not react with, for example, Group IV nanoparticles in such a way that it negatively affects the properties of the Group IV nanoparticles for their intended use. Likewise, an inert solvent is any solvent that does not react with embodiments of, for example, Group IV nanoparticles in such a way that it negatively affects the properties of the Group IV nanoparticles for their intended use. Finally, an inert solution is a mixture of two or more substances that does not react with, for example, Group IV nanoparticles in such a way that it negatively affects the properties of the Group IV nanoparticles for their intended use.

Examples of inert gases that may be used to provide an inert environment include nitrogen and the noble gases, such as argon. Though not limited by defining inert as only oxygen-free, since other fluids may react in such a way that they negatively affect the semiconductor, photoelectrical, and luminescent properties of the in situ modified Group IV nanoparticles, it has been observed that a substantially oxygen-free environment is indicated for producing suitable Group IV nanoparticles. As used herein, the terms “substantially oxygen free” in reference to environments, solvents, or solutions refer to environments, solvents, or solutions wherein the oxygen content has been reduced in an effort to eliminate or minimize the oxidation of the in situ modified Group IV nanoparticles in contact with those environments, solvents, or solutions.

The general procedure for producing nanoparticles in the current invention comprises continuously flowing one or more nanoparticle precursor gases into the plasma reactor chamber and igniting a RF plasma in the chamber. Within the plasma, precursor gas molecules dissociate and the elements of the nanoparticles nucleate and grow into nanoparticles. The precursor gases are desirably mixed with a buffer gas that acts as a carrier gas. The buffer gas is typically an inert gas (e.g., a rare gas) with a low thermal conductivity and a high molecular weight (in some instances, higher than that of the precursor molecules). Neon, argon, krypton and xenon are examples of suitable buffer gases.

The nanoparticle precursor gases contain precursor molecules that may be dissociated to provide precursor species that form nanoparticles in a radiofrequency plasma. Naturally, the nature of the precursor molecules will vary depending upon the type of nanoparticles to be produced. For example, to produce semiconducting nanoparticles, precursor molecules containing semiconductor elements are used.

If doped semiconductor nanoparticles are desired, the nanoparticle precursor gas may include semiconductor-containing precursor molecules (i.e., a primary nanoparticle precursor gas) and dopant-containing precursor molecules (i.e., a nanoparticle dopant precursor gas). Doped particles may be prepared using the plasma reactor system shown in FIG. 4, wherein one of the lines (e.g., third gas line 110) is used as a nanoparticle dopant precursor gas line and another line (e.g., first gas line 130) is used as a primary nanoparticle precursor gas line.

The production of nanoparticles may carried out at low pressures using a range of plasma parameters. For example, in some embodiments nanoparticles are produced in an RF plasma at a total pressure of no greater than about 25 Torr (e.g., about 3 Torr to about 25 Ton). Typical flow rates for the a primary nanoparticle precursor gas may be about 2 standard cubic centimeters (sccm) to about 30 sccm, while the flow rate for a dopant precursor gas may be about 60 sccm to about 150 sccm (about 1% of dopant in inert buffer gas such as Ar). The frequency of the RF power source used to ignite and/or sustain the RF plasma may vary within the RF range from 300 kHz to 300 GHz for the purpose of this invention. The 300 MHz to 300 GHz portion of this RF spectrum is often referred to as the microwave spectrum and the associated plasma is often referred to as microwave plasma.

Typically, however, a frequency of 13.56 MHz will be employed because this is the major frequency used in the radiofrequency plasma processing industry. However, the frequency will desirably be lower than the microwave frequency range (e.g., lower than about 1 GHz). This includes embodiments where the frequency will desirably be lower than the very high frequency (VHF) range (e.g., lower than about 30 MHz). For example, the present methods may generate radiofrequency plasmas using radiofrequencies of 25 MHz or less. Typical radiofrequency powers range from about 40 W to about 300 W.

As the reactor is scaled to larger sizes to allow the production of larger amounts of powder per unit of time, the flow rates can scale to values in the range of 10 liters per minute and plasma power in the range of 10 kW. The ranges provided above are for the purpose of illustration only. The optimal plasma parameters for a particular system will depend on the dimensions, geometry and materials of the plasma reactor, the nature of the precursor gases being employed, and the desired size and qualities of the nanoparticles. Therefore, in some instances, plasma parameters outside of the ranges cited above may be employed.

In addition, the RF power signal may be modulated with a secondary frequency to create complex RF waveforms, such as a sine wave, a sawtooth wave, a square wave, a triangle wave, or other composite waveforms.

### EXAMPLES

### Example 1

### Production of Conductive Thin Films Incorporating Phosphorous-Doped Silicon Nanoparticles

Two different sets of Si nanoparticles were produced using different plasma reactors, but substantially similar process conditions. In these experiments, silane was used as the primary nanoparticle precursor gas, Ar was used as the buffer gas, and phosphine was used as the nanoparticle dopant precursor gas. For both sets of nanoparticles, the Ar gas flow was set to 144 sccm and silane flow was maintained at 16 sccm. Dopant gas with a flow of 160 sccm was introduced from a separate gas source containing 99.9% Ar and 0.1% phosphine. Reactor pressure was controlled at 8.0 ton and the RF power supply was set to output 78 W of power.

A first plasma reactor was configured as a flow-through plasma reactor with a set of parallel non-concentric ring electrodes and a quartz tube configured to pass through the center of both non-concentric ring electrodes. The precursor gases were then flowed into the quartz tube with 19 mm outside diameter (OD). The two electrodes were separated by approximately 20 mm. The duration of the run was limited to ˜30 minutes as plasma was extinguished during longer runs by the buildup of a conductive film on the wall of the tube.

In contrast, the concentric-flow through plasma reactor of the present invention was configured with an outer quartz tube of 38 mm OD/35 mm inside diameter (ID). The size of inner quartz tube was 19 mm OD/16 mm ID. A grounded copper tube of OD 16 mm was inserted into the inner quartz tube to serve as the inner ground. The outer RF electrode was a copper band 25 mm in length and about 39 mm OD.

The two sets of nanoparticles were processed into films as follows. Prior to electrical test the entire process was done in a oxygen-free ambient environment. The particles were dispersed in chloroform/chlorobenzene solution (4:1 v/v ratio) with a concentration of 20 mg of powder per one mL of solvent. The solution was agitated using an ultrasonic horn for 15 minutes using a power setting of 35%. Approximately 300-350 μL of solution was deposited onto a 1×1 inch square quartz substrate and spun at 1000 rpm for 60 seconds. Additional solvent drying was performed by placing the substrate on a hotplate held at 100° C. for 30 minutes. The substrates were then placed face down on a silicon carrier wafer and heated to temperatures of 800-1000° C. for 30 seconds in a rapid thermal processor (RTP). The heating rate was approximately ˜30° C./second. The entire RTP process was performed in an Ar ambient environment.

After the high temperature treatment, 1500 Å thick aluminum lines were evaporated onto the films with variable spacing. The conductivity of the film was measured by applying a voltage between the aluminum lines and measuring the current carried by the Si film across the gap between the two aluminum lines.

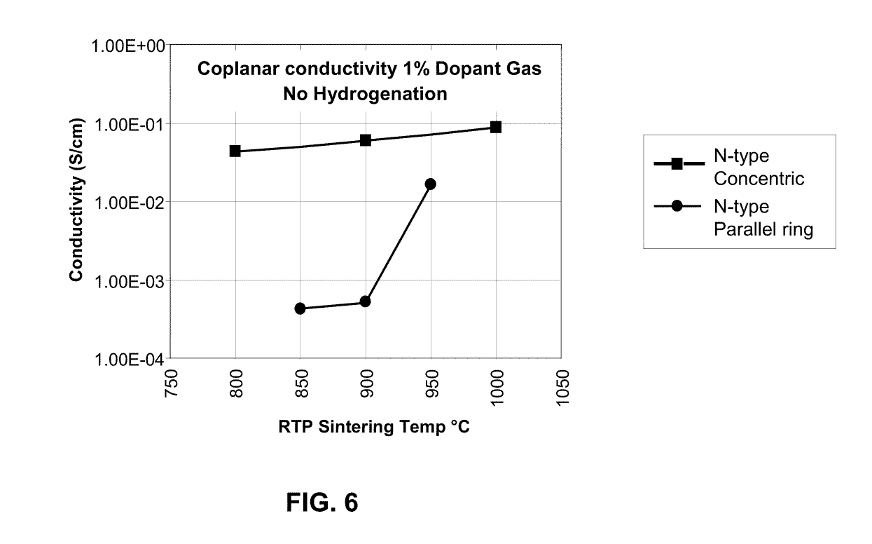

Referring now to FIG. 6, the conductivities of the films produced using the different reactor configurations are shown, in accordance with the present invention. The nanoparticles produced by the reactor with the concentric ring electrode assembly performs better not only in terms of a higher conductivity film (5-100 times), but also because the conductivity of the film is not as strongly dependent on temperature, providing for a wide process window.

### Example 2

### Production of SiO₂-Free Si Nanoparticles

Two different sets of Si nanoparticles were produced using different plasma reactors with substantially similar process conditions, in order compare the oxygen concentration. In these experiments, silane was used as the primary nanoparticle precursor gas and Ar was used as the buffer gas.

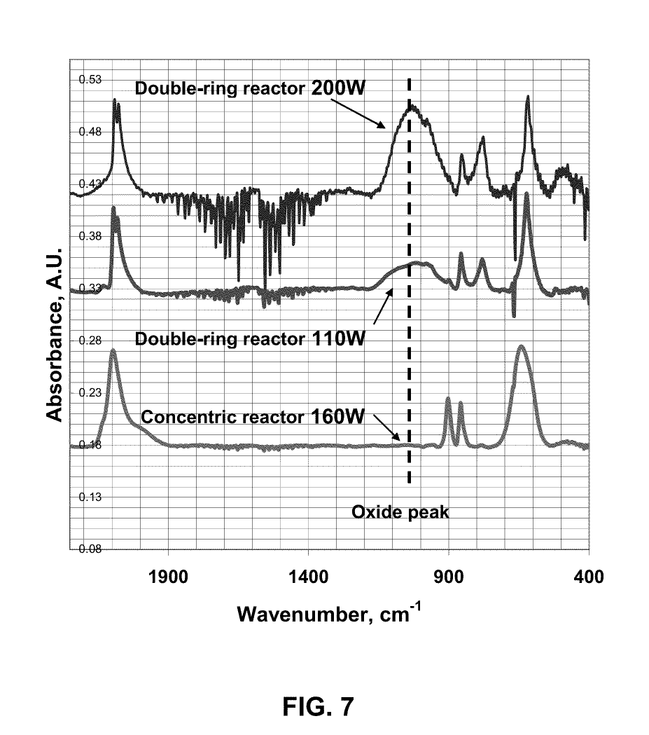

Referring now to FIG. 7, a graph is shown comparing the Fourier transform infrared spectroscopy (FTIR) spectrum for a powder of silicon nanoparticles produced in the present plasma apparatus with the FTIR spectrum of silicon nanoparticles made in a flow-through plasma reactor with a set of non-concentric electrodes.

A first plasma reactor was configured as a flow-through plasma reactor with a set of parallel non-concentric ring electrodes and a quartz tube configured to pass through the center of both non-concentric ring electrodes. The precursor gases were then flowed into the quartz tube with 19 mm outside diameter (OD). The two electrodes were separated by approximately 20 mm. The duration of the run was limited to ˜30 minutes as plasma was extinguished during longer runs by the buildup of a conductive film on the wall of the tube.

The precursor gases flowed into the quartz reactor tube with 19 mm outside diameter OD and a 16 mm inside diameter (ID). The two ring electrodes each had an OD of about 20 mm, a width of about 10 mm, and were separated by approximately 17 mm. The Ar gas flow was set to 304 sccm and silane flow was maintained at 16 sccm. Reactor pressure was controlled at 8.0 torr and the RF power supply was set to output 110 W to about 250 W of power during different runs. The Fourier transfer infrared spectra for the resulting nanoparticles, produced at a power of 110 W and a power of 200 W is shown in FIG. 7. The FTIR peak at 1050 cm⁻¹ shows that there is a significant amount of oxide in the nanoparticles formed in the 110-200 W power range.

The second electrode assembly employed a concentric electrode geometry. For the concentric electrode configuration, the size of outer quartz tube was 38 mm OD and 35 mm ID. The size of inner quartz tube was 19 mm OD and 16 mm ID. A grounded copper tube of OD 16 mm was inserted into the inner quartz tube to serve as the inner ground. The outer RF electrode was a copper band 25 mm in length, with an OD of about 39 mm. The Ar gas flow was set to 437 sccm and silane flow was maintained at 23 sccm. Reactor pressure was controlled at 8.0 torr and the RF power supply was set to output 160 W. The absence of an FTIR peak at 1050 cm⁻¹ in FIG. 7 shows that any oxide present in the resulting nanoparticles is below the detection limit of the FTIR system, which is typically less than 1% oxygen vs. silicon.

### Example 3

### Production of SiO₂-Free Si Nanoparticles

Two different sets of Si nanoparticle powders were produced to compare the oxygen concentration. The first powder was formed from silicon nanoparticles produced in a plasma reactor with silicon nitride coated-quartz dielectric layers. The second powder was formed from silicon nanoparticles produced in a plasma reactor with uncoated quartz dielectric layers. All other experimental parameters were substantially similar.

The plasma reactor chamber used in these experiments was a quartz tube with a 19 mm OD and a 16 mm ID. The radiofrequency ring electrode and the ground electrode were disposed around the quartz tube and both had an OD of about 20 mm and an ID of about 10 mm. The spacing between radiofrequency and ground electrodes was about 17 mm. In one experiment, the inner surface of the quartz tube was coated with a SiNₓ film prior to production of the silicon nanoparticles. The reaction parameters for the production of the coating were as follows: N₂ 100 sccm, SiH₄ 7.5 sccm, ˜580 mtorr and 7 W radiofrequency power.

The entire reactor was heated to 250° C. by wrapping with heating band before and during coating formation. The coating process continued for about 12 minutes. The resulting silicon nitride film was annealed at 500° C. for 30 minutes after the tube was coated. Si nanoparticles were then produced in the quartz tube without exposing the inside of the tube to the ambient air subsequent to coating formation and prior to nanoparticle formation.

The plasma reaction parameters for nanoparticle production in both experiments were: argon flow=304 sccm, silane flow=16 sccm, pressure=8.0 torr and radiofrequency power=110 W.

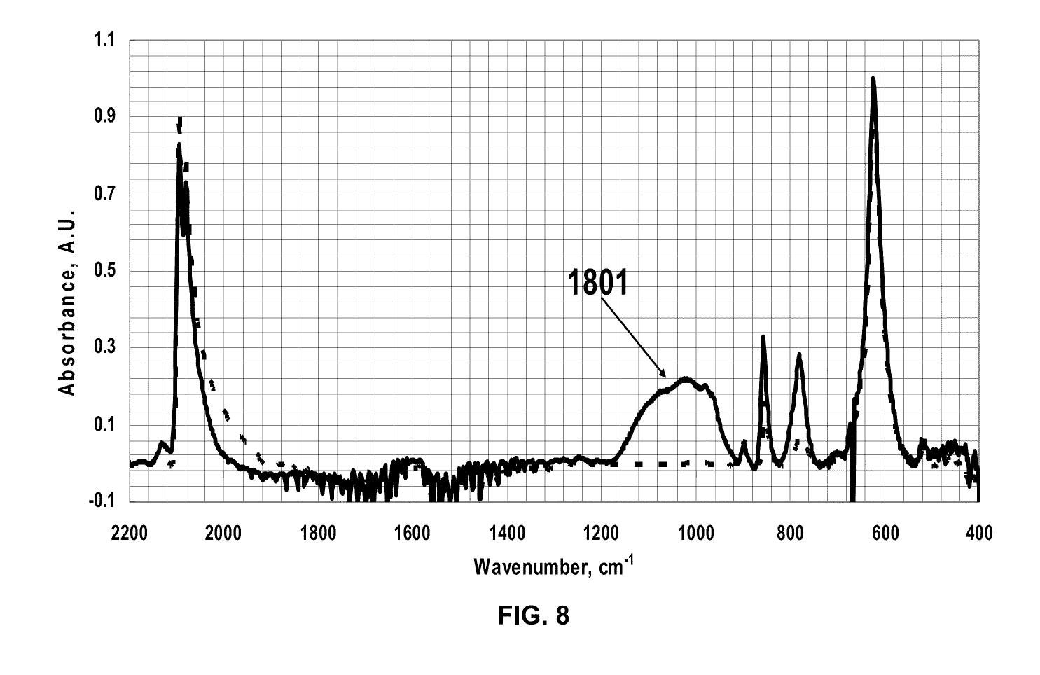

Referring now to FIG. 8, a simplified graph of a FTIR spectra for both sets of nanoparticles described above, in accordance with the present invention. As can be seen from the spectra that the strong SiO₂ peak 1801 present in the spectrum for the nanoparticles produced using the uncoated quartz tube (solid line) is substantially absent from the spectrum for the nanoparticles produced using the silicon nitride-coated quartz tube (dotted line).

### Example 4

### Production of Films from SiO₂-Free Si Nanoparticles

Two different films were formed from silicon nanoparticles. The first film was formed from silicon nanoparticles produced using a parallel ring electrode assembly with silicon nitride coated-quartz dielectric layers, as described in Example 3. The second film was formed from silicon nanoparticles produced using a parallel ring electrode assembly with uncoated quartz dielectric layers, as described in Example 3.

The films were produced by depositing the silicon nanoparticles on a substrate, followed by sintering of the deposited nanoparticles. Both films were deposited in an ink form via ink jet printing onto a Quartz/Molybdenum/poly-crystalline-Si substrate where the /poly-crystalline-Si layer formed a templating surface. A solvent drying step was performed by heating the film on a hot plate at 200° C. for 30 minutes. After this, the films were both heated in vacuum at a pressure below 2×10⁻⁵ ton and a temperature of around 800° C. for about 10 minutes. The reaction parameters for nanoparticle production in both experiments were: argon flow rate=304 sccm, silane flow rate=16 sccm, pressure=8.0 ton and radiofrequency power=60 W. For both films, sintering was conducted at 820° C. for 6 minutes at a pressure of between 1×10⁻⁵ ton and 1×10⁻⁶ ton.

Scanning electron microscopy images revealed that the film produced from the silicon nanoparticles made in the uncoated quartz tube had a high level of porosity and poor densification. In contrast, the film produced from the silicon nanoparticles made in the silicon nitride-coated quartz tube was much denser. This experiment showed how the SiNₓ coating can have an impact on the properties of a thin film formed form the nanoparticles.

For the purposes of this disclosure and unless otherwise specified, “a” or “an” means “one or more.” All patents, applications, references and publications cited herein are incorporated by reference in their entirety to the same extent as if they were individually incorporated by reference.

The invention has been described with reference to various specific and illustrative embodiments. However, it should be understood that many variations and modifications may be made while remaining within the spirit and scope of the invention. Advantages of the invention include the production of commercial-scale quantities of high-quality crystalline nanoparticles in a substantially continuous fashion. Additional advantages include the avoidance of conductive film build-up between ground electrode and RF electrodes.

Having disclosed exemplary embodiments and the best mode, modifications and variations may be made to the disclosed embodiments while remaining within the subject and spirit of the invention as defined by the following claims.

What is claimed is:

1. A method for producing nanoparticles, comprising
a) introducing a nanoparticles precursor gas into an annular channel of a plasma apparatus;
b) igniting a plasma in the annular channel and thereby dissociating the nanoparticles precursor gas and forming nanoparticles.

2. The method of claim 1, wherein said plasma apparatus comprises:
i) an outer tube, the outer tube including an outer tube longitudinal length, an outer tube inner surface, and an outer tube outer surface,
ii) an inner tube, the inner tube including an inner tube longitudinal length and an inner tube outer surface, wherein the outer tube inner surface and the inner tube outer surface define said annular channel,
iii) an outer electrode tube, the outer electrode tube including an outer electrode tube longitudinal length, the outer electrode tube having an outer electrode inner surface disposed on the outer tube outer surface, and
iv) a central electrode, the central electrode including a central electrode longitudinal length, the central electrode being disposed inside the inner tube; and
and wherein said igniting the plasma in the annular channel comprises applying energy to the outer electrode or the central electrode.

3. The method of claim 2, wherein said energy is applied by an energy source that is coupled to the outer electrode, while the central electrode is grounded.

4. The method of claim 2, wherein said energy is applied by an energy source that is coupled to the central electrode, while the outer electrode is grounded.

5. The method of claim 1, further comprising collecting the nanoparticles formed in the annular channel.

6. The method of claim 5, wherein said collecting comprises collecting the nanoparticles as a powder in a nanoparticle collection chamber, which is in fluid communication with an outlet of the annular channel.

7. The method of claim 5, wherein said collecting is done on a substrate or a grid housed in the plasma apparatus.

8. The method of claim 1, further comprising introducing an inert gas into the annular channel, so that the inert gas mixes with the nanoparticles precursor gas.

9. The method of claim 1, wherein the nanoparticle precursor gas comprises primary nanoparticle precursor molecules and nanoparticle dopant precursor molecules.

10. The method of claim 1, wherein the nanoparticle precursor gas comprises a Group IV element and the nanoparticles comprise Group IV nanocrystals.

11. The method of claim 1, wherein the nanoparticle precursor gas comprisies silicon and the nanoparticles are silicon nanoparticles.

12. The method of claim 1, wherein the nanoparticles are formed at a pressure in the annular channel of no greater than 30 Torr.

13. The method of claim 1, wherein at least 1 g of the nanoparticles is formed per hour.

14. The method of claim 1, wherein the nanoparticles are free or substantially free of oxides.

15. The method of claim 1, wherein said igniting the plasma comprises igniting a radiofrequency plasma.
